(19) United States
(12) Patent Application Publication
(10) Pub. No.: US 2025/0242906 A1
(43) Pub. Date: Jul. 31, 2025

(54) METHOD FOR MANUFACTURING AN AERODYNAMIC PROFILE

(71) Applicant: DUFOUR AEROSPACE AG, Visp (CH)

(72) Inventors: Simon BENDREY, Gränichen (CH); Andrew LEE, Auenstein (CH)

(21) Appl. No.: 18/856,494

(22) PCT Filed: Apr. 11, 2022
(86) PCT No.: PCT/EP2022/059604

§ 371 Date: Oct. 11, 2024

(51) Int. Cl. B64C 3/20; B29D 99/00; B29K 263/00; B29K 307/04; B64C 1/00; B64C 5/00

(52) U.S. Cl. CPC B64C 3/20; B64C 1/00; B64C 5/00; B29D 99/0028; B29K 2263/00; B29K 2307/04; B64C 2001/0072; B64C 2001/0081

(57) ABSTRACT

An aerodynamic profile for an aircraft, comprises a core (6, 7, 8) made of foam, a skin (11, 12) defining an outer surface of the wing and cloths (14) form-ing spars and/or ribs. The profile comprises a wing, a canard, a horizontal stabiliser, a vertical stabiliser, an aileron, a flaperon, a wingtip winglet, an elevator, an elevon, a rudder or a flap.

### TECHNICAL FIELD

The invention relates to an aerodynamic profile for an aircraft, comprising a core made of foam and a skin defining an outer surface of the aerodynamic profile. The aerodynamic profile comprises cloths forming spars and/or ribs. The profile is selected from the group consisting of: a wing, a canard, a horizontal stabiliser, a vertical stabiliser, an aileron, a flaperon, a wingtip winglet, an elevator, an elevon, a rudder or a flap.

Furthermore, the invention relates to a method for manufacturing such an aerodynamic profile. A lower skin defining an outer surface is laid in a mould. Core is placed in the mould to support the skins. An upper skin defining an outer surface is laid in the mould. The mould is closed and the profile is cured.

### BACKGROUND ART

Traditionally, a composite wing for a general aviation category aircraft is manufactured using a bonded assembly method. Individual components, such as skins, spars or ribs, are laminated in individual negative moulds and bonded together to form the complete wing. Each part is manufactured in a single mould and all parts have to be assembled afterwards. This method takes time and many different moulds are required. Costs for production facilities are high.

### DISCLOSURE OF THE INVENTION

The problem to be solved by the present invention is to provide an aerodynamic profile which is easy to manufacture.

This problem is solved by an aerodynamic profile for an aircraft, comprising
a core made of foam;
a skin defining an outer surface of the aerodynamic profile;
cloths forming spars and/or ribs.

The profile can be a wing, a canard, a horizontal stabiliser, a vertical stabiliser, an aileron, a flaperon, a wingtip winglet, an elevator, an elevon, a rudder or a flap.

Foam is an object formed by trapping pockets of gas. In particular, the foam can be made of polyurethane, polyvinyl chloride, polymethacrylimide or honeycomb. Different parts of the core can be made by different foams, e.g. by foams of different densities or different compositions. Nonetheless, the whole core can be made with the same foam. For example, the foam can have a density between 40 kg/m³ and 80 kg/m³. A foam part arranged at the leading edge can have a higher density, e.g. higher than 150 kg/m³. The core made of foam replaces the air gaps in the traditional wing assembly.

Skin and cloths can be made of composite material, in particular carbon fiber reinforced plastic. Skin can include a layer made of copper or aluminium mesh in order to provide additional protection. The composite material preferably used can be made of a thermosetting matrix, in particular a polymer matrix, reinforced with fibers. The polymer can be epoxy such as LG 285 plus hardener. The cloth can be woven, non-woven, have unidirectional fibers, can comprise aramid or glass.

The aerodynamic profile is easy to manufacture. It is not necessary to manufacture many different components which have to be assembled. Spars and ribs are created by wrapping cloths around splits in the core. Non-recurring costs for production facilities are reduced. The manufacturing time is significantly shorter, in particular about seven times shorter, which reduces recurring costs massively.

The downside is the aerodynamic profile is slightly heavier than the traditionally made aerodynamic profile, but the performance is identical.

Advantageously, the profile comprises splits, in particular splits separating the core in different parts of the core. Cloths forming spars and/or ribs are arranged in the splits, in particular wherein the cloths build spar webs. Cloths arranged in the splits are wrapped around the core.

Arranging and wrapping cloths in splits of the core is easy to manufacture because no location tools are required to position spars and ribs inside the wing. The cloths can be wet assembled. In particular cloths can be pre-impregnated which delivers a lighter and better consolidated structure. A pre-impregnated profile has less variation in thickness.

Advantageously, the core comprises recesses on its outer side and wherein the aerodynamic profile comprises reinforcing elements arranged in the recesses. Reinforcing profiles can be as examples: spar cap, interface bracket, hinge ribs. In particular, these reinforcing elements can be made of aluminium, titanium, plastic, forged carbon, pultruded unidirectional carbon, roving, unidirectional cloths or something else.

Advantageously, the reinforcing elements are wrapped by the cloths. Wrapping reinforcing elements by cloths stabilizes the assembly and simplifies the manufacture of the profile.

Advantageously, the aerodynamic profile comprises trailing edge ribs which support control surfaces, in particular made of aluminium, titanium, plastic or forged carbon.

In particular, an aircraft comprises said aerodynamic profile.

Another problem to be solved by the present invention is to provide a method for manufacturing an aerodynamic profile as described. This problem is solved by a method comprising the following steps:
A lower skin defining an outer surface is laid in a mould;
Core made of foam is placed in the mould to support the skins;
An upper skin defining an outer surface is laid in the mould;
Closing the mould and curing the profile.

In particular, skins are pre-cut material and cores can be pre-machined to shape as required. After closing the mould, pressure is applied and the aerodynamic profile is cured. After curing process, the aerodynamic profile is de-moulded and parts might be trimmed. The mould is cleaned for reuse.

Tools are designed containing location features to position the core or core parts, structural inserts and reinforcing profiles prior to curing process.

Advantageously, cloths are wrapped around the core during manufacturing, in particular wherein cloths are fixed to the core, in particular by adhesives, to prevent movement of the cloths during curing process. Cloths wrapped around the core can form spars and ribs. In particular, cloths are arranged or wrapped in splits of the core before closing the mould.

The manufacturing method described requires significantly fewer tools for manufacturing the aerodynamic profile. Traditional methods require separate tools for manufacturing all ribs and spars. With the disclosed method, spars and ribs are created by wrapping cloths around a core made of foam or parts of a core made of foam. Cores made of foam are premanufactured.

If spar caps, e.g. made of UD pultruded carbon, are integrated into the aerodynamic profile in order to reinforce the aerodynamic profile at several locations, the spar caps are wrapped with cloths before closing the mould. This is a very easy way to position reinforcing spar caps within the assembly.

Advantageously, the core is oversized before placing the core in the mould. The core is oversized by a small percentage dependent on thickness to enable a small amount of core crush to aid consolidation of the component during curing process. The moulds are clamped together during curing process to provide constant pressure to the aerodynamic profile. Heat is applied to improve resin flow for better consolidation.

Advantageously, structural inserts made from carbon, plastic or metal are located within the mould before closing the mould.

Other advantageous embodiments are listed in the dependent claims as well as in the description below.

### BRIEF DESCRIPTION OF THE DRAWINGS

The invention will be better understood and objects other than those set forth above will become ap-parent from the following detailed description thereof. Such description makes reference to the annexed drawings, wherein:

FIG. 1 shows a cross section of a wing according to the invention;

FIG. 2 shows a cross section of a wing with a structural insert for an external device;

FIG. 3a to 3d illustrate a method for manufacturing a wing.

### MODE FOR CARRYING OUT THE INVENTION

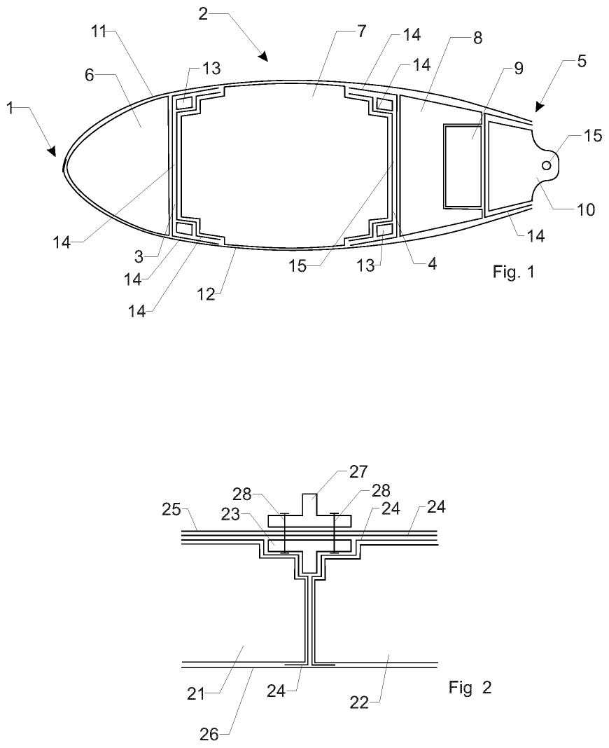

FIG. 1 shows a wing. It comprises a leading edge 1, a central portion 2 located between a first main spar 3 and a second main spar 4 and a trailing edge 5. It comprises three cores 6, 7, 8 made of foam. The first core 6 is arranged between the leading edge 1 and the first main spar 3, the second core 7 is arranged between the first main spar 3 and the second main spar 4. The third core 8 is arranged between the second spar 4 and the trailing edge 5. A structural insert 9 and a trailing edge rib 10 are arranged at the trailing edge 5. An upper skin 11 and a lower skin 12 define an outer surface of the wing.

The cores 6, 7 and 8 are made of foam. The foam is made of low density PVC. The cores 6, 7 and 8 substitute spaces filled with air of traditional wings.

Main spars 3 and 4 comprise spar caps 13 made of UD carbon rods. Spar caps 13 are wrapped with cloths 14 made of carbon fiber reinforced plastic. The cloths 14 build the spar webs 15. Spar caps 3 and 4 give strength to the assembly, cores 6, 7, 8 made of foam give stiffness to the assembly. Spar caps 3 and 4 receive the bending moment of the wing. Spar webs 15 receive shear loading balancing the end load in the caps. The spar webs 15 made by cloths 14 are arranged in splits between the cores 6, 7, and 8.

The trailing edge rib 10 is a structural rib not made of cloth, but e.g. made of aluminium. It comprises a hinge 15 for mounting control surfaces like flaps or ailerons (not shown). The structural insert 8 is made of aluminium and gives additional strength to the wing to support the loads from the control surface.

The upper skin 11 and the lower skin 12 are made of carbon fiber-reinforced plastic. The skins 11 and 12 can comprise an additional layer for providing protection for the wing. For example the additional outer layer can be made of copper or aluminium for lightning strike protection.

In order to embed spar caps or other structural inserts into the wing, recesses are machined out from the cores to permit the location of the spar caps in the cores.

Skins 11 and 12 and cloths 14 can be made of several layers of textile. The layers can have the same or different orientations.

FIG. 2 shows a detailed view of a cross section of another wing. The wing comprises cores 21 and 22 made of foam. A recess is machined out into both cores in order to embed a structural insert 23 into the assembly. The structural insert is wrapped by cloths 24 on all sides. Upper skin 25 and lower skin 26 are visible in FIG. 2.

The structural insert 23 is provided to mount an external device 27 to the wing, like an engine, flaps etc. Structural insert 23 and external device 27 are further attached by fasteners 28.

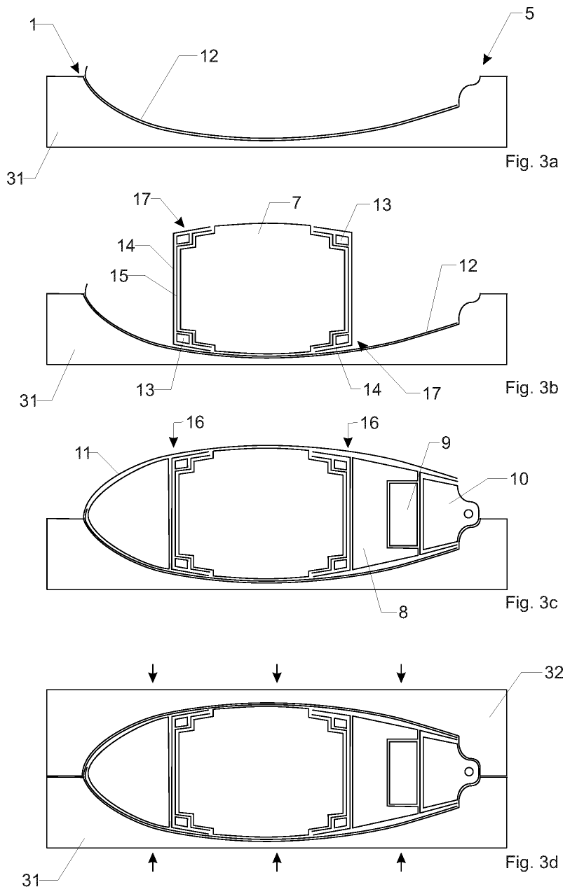

FIGS. 3a until 3d illustrate a method for manufacturing the described wing. FIG. 3a shows a first part 31 of a negative mould. In a first step, the lower skin 12 is laid in the first part 31 of the negative mould.

As shown in FIG. 3b, pre-cured spar caps 13 are wrapped by several cloths 14 made by carbon fiber reinforced plastic in a second step. At this point the cloths 14 are still wet and not cured. In order to embed the spar caps 13 wrapped by cloths, recesses 17 are machined out from the second core 7 made of foam.

In a third step, the spar caps 13 wrapped by cloths 14 are wrapped around the second core 7 made of foam. The cloths 14 are fixed to the second core 7 by adhesives or staples in order to prevent movement during assembly and curing process. Cloths 14 form spar webs 15 such that cloths 14 and spar caps 13 form complete spars of the wing. The second core 7 and the spar caps 13 wrapped by cloths 14 are laid in the mould on the lower skin 12.

As shown in FIG. 3c, a first core 6, a third core 8, a structural insert 9 and a trailing edge rib 15 are arranged on the lower skin 12. The upper skin 11 is laid on the assembly. The spar webs 15 are arranged in splits 16 between the cores 6, 7 and 8.

The assembly is oversized by a small percentage to enable a small amount of core crush to aid consolidation of the components during curing process.

The mould is closed by a second part 32 of the mould. This is shown in FIG. 3d. The first part 31 and the second part 32 are clamped together and constant pressure is applied during curing process. Heat is applied to improve resin flow for better consolidation.

The described method is for manufacturing a wing in a single “shot” lamination process. Features such spars and ribs are formed by arranging cloths in splits of the cores of foam.

The disclosed technology can be applied to other aerodynamic profiles, like aileron, flaperon, elevator etc. It is possible to manufacture only the fuselage in a traditional way, but everything else can be manufactured by the disclosed technology.

1. An aircraft with an aerodynamic profile, wherein the aerodynamic profile comprises
a core made of foam,
a skin defining an outer surface of the aerodynamic profile,
cloths forming spars and/or ribs,
wherein the profile is a profile selected from the group consisting of: a wing, a canard, a horizontal stabiliser, a vertical stabiliser, an aileron, a flaperon, a wingtip winglet, an elevator, an elevon, a rudder or a flap.

2. The aircraft according to claim 1, wherein the core comprises splits separating the core in different parts.

3. The aircraft according to claim 2, wherein the cloths forming spars and/or ribs are arranged in the splits, in particular wherein the cloths build spar webs.

4. The aircraft according to claim 1, wherein the cloths and/or the skin are made of carbon fiber-reinforced plastic.

5. The aircraft according to claim 1, wherein the core comprises recesses on its outer side and wherein the aerodynamic profile comprises reinforcing elements arranged in the recesses.

6. The aircraft according to claim 5, wherein the reinforcing profiles are reinforcing elements selected from the group consisting of: spar cap, interface bracket, hinge ribs.

7. The aircraft according to claim 5, wherein the reinforcing elements are made of a material from the group consisting of: aluminium, titanium, plastic, forged carbon.

8. The aircraft according to claim 3 and according to claim 5, wherein the reinforcing elements are wrapped by the cloths.

9. The aircraft according to claim 1, comprising trailing edge ribs which are wrapped by the cloths, in particular wherein the trailing edge ribs are made of a material different to the cloths.

10. Method for manufacturing an aircraft according to claim 1, comprising the following steps for manufacturing the aerodynamic profile:
the lower skin defining the outer surface of the aerodynamic profile is laid in a mould;
the core is placed in the mould to support the skins;
the upper skin defining the outer surface of the aerodynamic profile is laid in the mould;
closing the mould and curing the profile.

11. Method according to claim 10, comprising the following step:
the cloths are wrapped around the core or parts of the core,
in particular wherein the cloths are fixed to the core, in particular by adhesive, to prevent movement of the cloths during curing.

12. Method according to claim 10 for manufacturing an aircraft according to claim 2 comprising the following step:
arranging the cloths in splits of the core before closing the mould.

13. Method according to claim 10 for manufacturing an aircraft, comprising the following steps:
wrapping the reinforcing elements, in particular the spar caps, with the cloths before closing the mould.

14. Method according to claim 10, comprising the following steps:
the core is oversized before placing the core in the mould.

15. Method according to claim 10, wherein structural inserts made from carbon, plastic or metal are located within the mould.
